(19) United States
(12) Patent Application Publication
(10) Pub. No.: US 2006/0012254 A1
(43) Pub. Date: Jan. 19, 2006

(54) Finned rear housing for alternator

(75) Inventors: Gary Michael Einheuser, Milford, MI (US); Carl William Cenzer, Brighton, MI (US); Michael Edward Harris, Saline, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/890,949

(22) Filed: Jul. 14, 2004

(51) Int. Cl. H02K 9/00

(52) U.S. Cl. 310/58; 310/60 R; 310/68 D

(57) ABSTRACT

An electric machine of the present application comprises a generally cylindrically-shaped main housing and a fan extending from a rear end of the main housing. A rear housing is mounted onto the rear end of the main housing and encloses the fan. The rear housing includes a rear plate having an outer surface and an inner surface, a support rim which is mounted onto the stator to secure the rear housing to the electric machine, and a plurality of axially extending ribs spaced circumferentially around and interconnecting the support rim and the rear plate.

### BACKGROUND

1. Field of the Invention

The present invention relates generally to an alternator with improved cooling characteristics.

2. Description of Related Technology

In most alternators, internal fans pull ambient air into openings in the rear of the alternator. As the air flows through the alternator and across the components of the alternator the air heats up. This heated air exits from the inside of the alternator through openings in the outer diameter of the rear housing, but the difference between the heated air and the hot housing is not large enough to provide sufficient cooling to the housing. Therefore, there is a need for an alternator with more efficient and effective cooling of the alternator components and the housing.

### SUMMARY

An alternator incorporating the features of the present application includes a generally cylindrically-shaped main housing and stator and a fan extending from a rear end of the rotor. A rear housing is mounted onto the rear end of the stator and encloses the fan. The rear housing including a rear plate having an outer surface and an inner surface and a support rim that is mounted onto the stator to secure the rear housing to the main housing. A plurality of axially extending ribs are spaced circumferentially around and interconnect the support rim and the rear plate.

In an aspect of the present application, the outer surface of the rear plate includes a plurality of axially extending radially aligned cooling fins positioned radially outward of and spaced circumferentially around openings formed within the rear plate, such that when the fan draws air inward through the openings in the rear plate, air is drawn over and between the cooling fins, providing ambient air cooling of the rear housing.

In another aspect of the present application, the alternator includes an end cap mounted onto the rear housing. The end cap includes a rim portion attached to the rear housing, and a dome portion including a cylindrical side wall and an end face. The end face includes a plurality of vents formed therein to allow ambient air be drawn inward. The end cap may further include a plurality of slots formed within said side wall to allow ambient air to be drawn inward.

In yet another aspect of the present application, a heat sink is mounted onto the rear housing, within the end cap. The heat sink includes a plurality of axially extending radially aligned cooling fins. The cooling fins of the heat sink are axially aligned with the vents in the end cap such that ambient air drawn in through the vents passes over and between the cooling fins of the heat sink. The heat sink provides further cooling of the components within the rear housing of the alternator.

### DESCRIPTION OF THE DRAWINGS

The above, as well as other advantages of the present invention, will become readily apparent to those skilled in the art from the following detailed description of the embodiments when considered in the light of the accompanying drawings in which:

FIG. 1 is a perspective view of an alternator having features of the present application;

FIG. 2 is a side sectional view of an the alternator of FIG. 1;

FIG. 3 is a schematic illustration of the portion of the alternator enclosed within the circle 3-3 of FIG. 2;

FIG. 4 is an exploded view of an alternator having features of the present invention;

FIG. 5 is a perspective view of a rear housing as described in the present application;

FIG. 6 is a perspective view of an end cap as described in the present application;

FIG. 7 is a perspective view of a heat sink as described in the present application; and

FIG. 8 is a perspective view of the rear housing, the heat sink, and the end cap wherein a portion of the end cap is broken away to illustrate the position of the heat sink on the rear housing and the end cap enclosing the heat sink.

### DESCRIPTION OF THE EMBODIMENTS

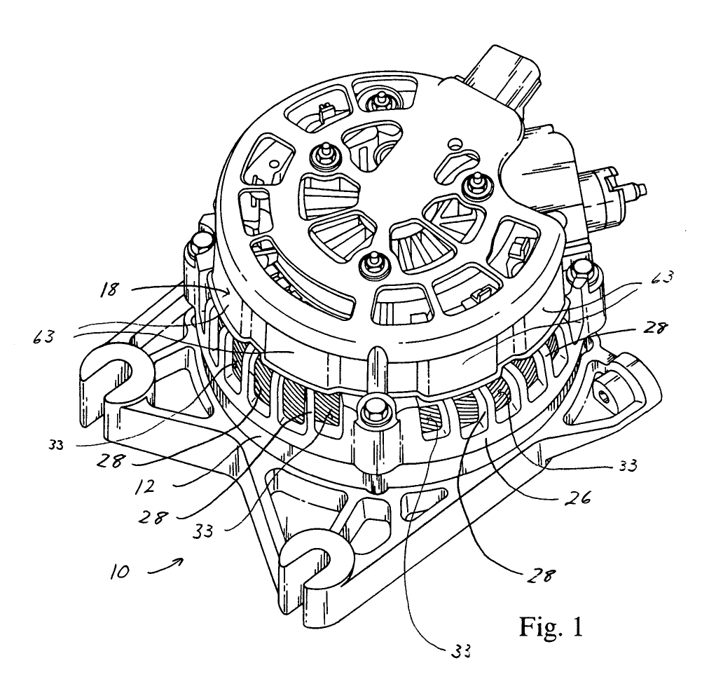

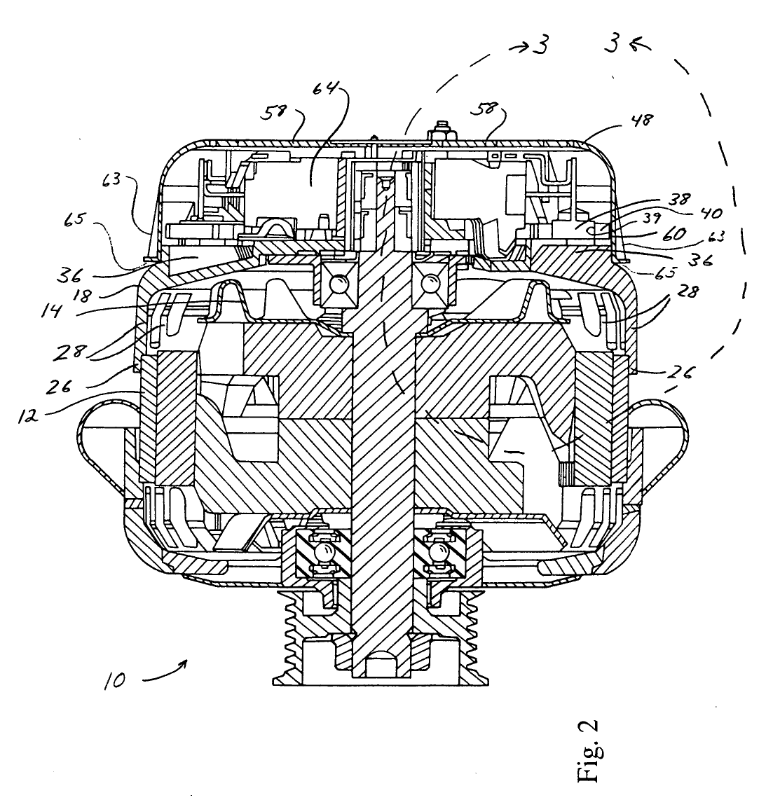

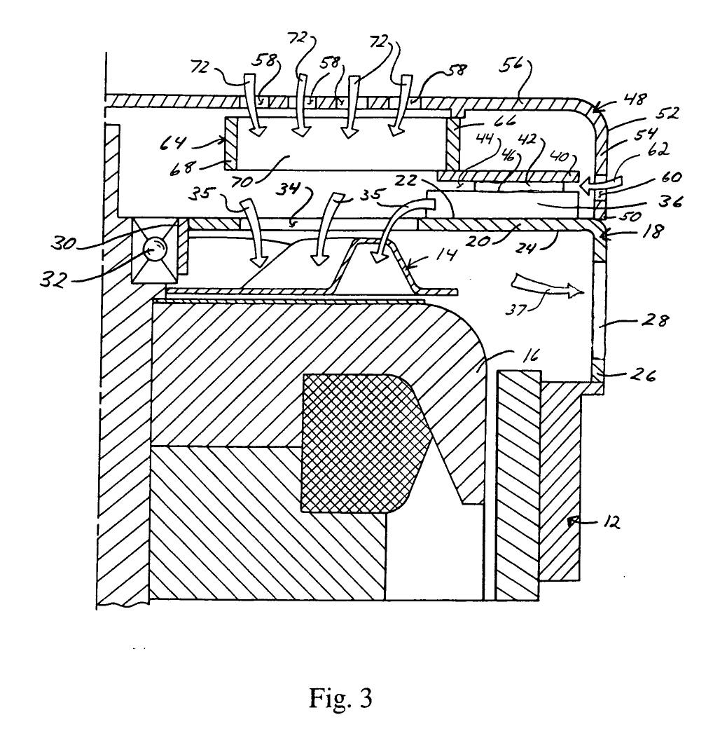

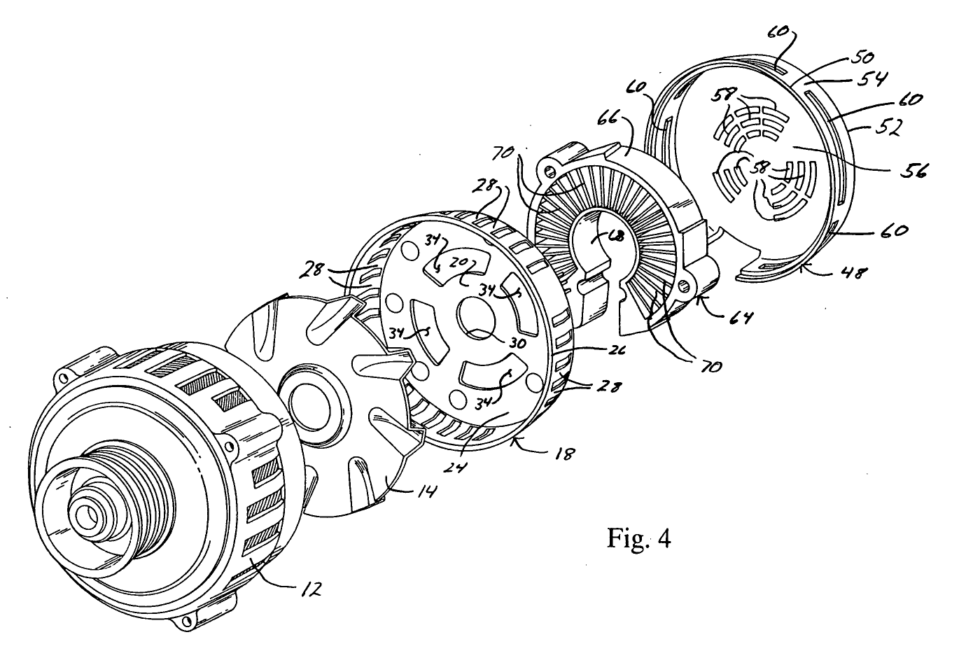

Referring now to FIGS. 1 and 2, an electric machine of the present application is shown generally at 10. Referring to FIG. 3, a simplified view of a portion of FIG. 2 is shown to more clearly illustrate the features of the present application. The electric machine 10, in this instance an alternator, includes a generally cylindrically-shaped main housing and stator 12 and a fan 14 attached to the rear end of the rotor 16. A rear housing 18 is mounted onto the rear end of the stator 12 and encloses the fan 14. The rear housing 18 includes a rear plate 20 having an outer surface 22 and an inner surface 24. A plurality of axially extending ribs 28 extend from the inner surface 24, and are spaced circumferentially around the rear plate. A support rim 26 is mounted onto the distal ends of the ribs 28. The support rim 26 is mounted onto the stator 12 to secure the rear housing 20 to the stator 12.

The rear plate 20 includes a central bore 30 formed therein to accommodate a bearing 32 for the alternator 10. A plurality of openings 34 are formed within the rear plate 20 to allow ambient air to be drawn into the alternator 10, as indicated by arrows 35 in FIG. 3. The openings 34 are positioned radially outward of and spaced circumferentially around the central bore 30. Ambient air is drawn inward through the openings 34 in the rear plate 20 of the rear housing 18 and is exhausted outward from the alternator 10 through the openings 33 defined between adjacent ribs 28 of the rear housing 18, as indicated by arrow 37 in FIG. 3.

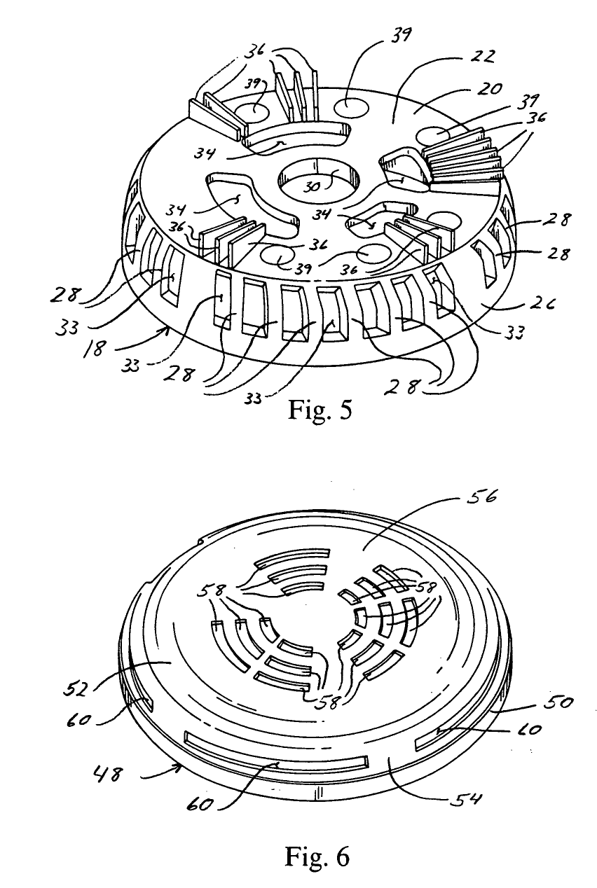

As also seen in FIGS. 3 and 5, the outer surface 22 of the rear plate 20 further includes a plurality of axially extending, radially aligned cooling fins 36. The cooling fins 36 are positioned radially outward of and spaced circumferentially around the openings 34 in the rear plate 20. When the fan 14 draws air inward through the openings 34, the air is drawn over and between the cooling fins 36, thereby providing cooling of the rear housing 18 with air that is not already pre-heated by the internal components of the alternator 10.

The alternator 10 further includes a plurality of rectifying diodes 38 mounted thereon. As shown in FIGS. 2 and 5, the rectifying diodes 38 can be mounted within pockets 39 directly onto the rear plate 20. Alternatively, the rectifying diodes 38 can be mounted onto a diode plate 40.

Referring to FIG. 3, a diode plate 40 is shown mounted onto the rear housing 18 axially outward of the cooling fins 36 such that the cooling fins 36 are positioned between the diode plate 40 and the outer surface 22 of the rear plate 20. To mount and support the diode plate 40, the rear housing 18 includes a plurality of supports 42 extending axially from the outer surface 22 of the rear plate 20, axially outward further than the cooling fins 36, with the diode plate 40 mounted onto the supports 42. A gap 44 is defined between the diode plate 40 and a top surface 46 of the cooling fins 36, to allow ambient air to flow therebetween.

An end cap 48 is mounted onto the rear housing 18 to enclose the previously mentioned components. As seen in FIGS. 3 and 6, the end cap 48 includes a rim portion 50 attached to the rear housing 18, and a dome portion 52 including a cylindrical side wall 54 and an end face 56. The end face 56 includes a plurality of vents 58 formed therein to allow ambient air be drawn inward. The end cap 48 further includes a plurality of slots 60 formed within the side wall 54 to also allow ambient air to be drawn inward. Preferably, the slots 60 within the side wall 54 of the end cap 48 are radially aligned with the cooling fins 36 such that ambient air drawn inward through the slots 60 passes over and between the cooling fins 36 of the rear housing 18, as indicated by arrow 62 of FIG. 3.

The end cap 48 may also include flared out portions 63 which allow ambient air to be drawn into the end cap 48. Referring to FIGS. 1 and 2, the flared portions 63 define an air gap 65 between the end cap 48 and the rear housing 18 that allows air to flow inward within the end cap 48.

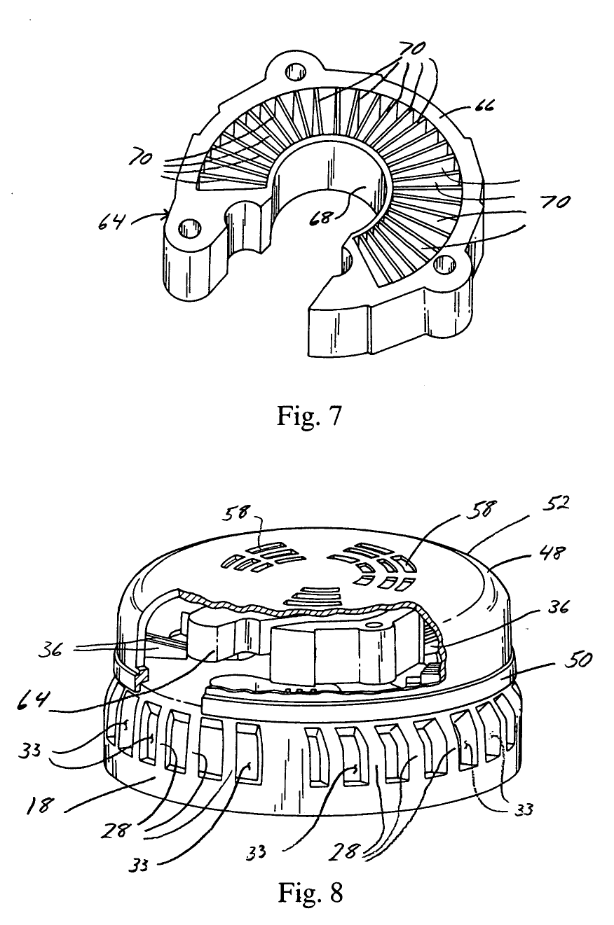

A heat sink 64 may be mounted onto the rear housing 18 within the end cap 48. As seen in FIGS. 3 and 7, the heat sink 64 is generally ring shaped having a outer rim 66, and inner rim 68, and a plurality of axially extending radially aligned cooling fins 70, the later of which extend radially between the inner rim 68 and the outer rim 66. The cooling fins 70 of the heat sink 64 are aligned with the vents 58 formed within the end face 56 of the end cap 48. Ambient air drawn in through the vents 58 passes over and between the cooling fins 70 of the heat sink 64, as indicated by arrows 72 of FIG. 3.

In accordance with the provisions of the patent statutes, the features of the present application have been described in various specific embodiments. However, it should be noted that the features of the present application can be practiced otherwise than as specifically illustrated and described herein.

What is claimed is:

1. An electric machine comprising:
a generally cylindrically-shaped stator;
a fan extending from a rear end of said electric machine; and
a rear housing mounted onto said stator at said rear end of said electric machine and enclosing said fan, said rear housing including a rear plate having an outer surface and an inner surface, a support rim securing said rear housing to said stator,
said support rim being connected to said rear plate by a plurality of axially extending ribs spaced circumferentially around said support rim, adjacent ones of said ribs defining openings therebetween.

2. The electric machine of claim 1 wherein said rear plate includes a plurality of circumferentially spaced openings formed therein, whereby said fan is adapted to draw air inward through said openings in said rear plate and to exhaust air outward over and around said ribs.

3. The electric machine of claim 2 wherein said outer surface of said rear plate further includes a plurality of axially extending, radially aligned cooling fins, said cooling fins being positioned radially outward of said openings such that when said fan draws air inward through said openings in said rear plate air is drawn over and between said cooling fins.

4. The electric machine of claim 3 wherein said rear plate further includes a plurality of rectifying diodes mounted thereon.

5. The electric machine of claim 4 wherein said rectifying diodes are press fit within pockets formed within said rear plate.

6. The electric machine of claim 3 further including a diode plate mounted onto said rear housing axially outward of said cooling fins such that said cooling fins are positioned between said diode plate and said outer surface of said rear plate, said diode plate including a plurality of rectifying diodes mounted thereon.

7. The electric machine of claim 6 wherein said rear housing further includes a plurality of supports extending axially from said outer surface of said rear plate, said diode plate being mounted onto said supports.

8. The electric machine of claim 7 wherein said supports extend axially outward further than said cooling fins such that there is a gap between said diode plate and a top surface of said cooling fins.

9. The electric machine of claim 3 further including an end cap mounted onto said rear housing, said end cap having a dome portion including a cylindrical side wall and an end face, said end face including a plurality of vents formed therein to allow ambient air be drawn inward.

10. The electric machine of claim 9 wherein said end cap further includes a plurality of slots formed within said side wall to allow ambient air to be drawn inward.

11. The electric machine of claim 10 wherein said slots within said sidewall of said end cap are aligned with said cooling fins such that ambient air drawn inward through said slots passes over and between said cooling fins of said rear housing.

12. The electric machine of claim 9 further including a heat sink mounted onto said rear housing beneath said end cap.

13. The electric machine of claim 12 wherein said heat sink includes a plurality of axially extending radially aligned cooling fins, said cooling fins of said heat sink being aligned with said vents in said end cap such that ambient air drawn in through said vents passes over and between said cooling fins of said heat sink.

14. The electric machine of claim 9 wherein said end cap further included a plurality of flared portions defining an air gap between said end cap and said rear housing such that ambient air can be drawn inward through the air gap.

15. The electric machine of claim 1 wherein said electric machine is an alternator.

16. A rear housing for mounting to a main housing of an electric machine, said rear housing comprising:
a rear plate having an outer surface and an inner surface;
a support rim to attach said rear housing to the main housing of the electric machine; and
a plurality of axially extending ribs spaced circumferentially around and interconnecting said support rim and said rear plate, adjacent ones of said ribs defining opening therebetween.

17. The rear housing of claim 16 wherein said rear plate includes a plurality of openings formed therein, said openings being spaced circumferentially around said rear plate, wherein said openings are adapted to allow ambient air to be drawn inward through said openings in said rear plate of said rear housing and to be exhausted outward over and around said ribs of said rear housing.

18. The rear housing of claim 17 wherein said outer surface of said rear plate further includes a plurality of axially extending, radially aligned cooling fins spaced circumferentially around said rear plate, said cooling fins being positioned radially outward of said openings such that when ambient air is drawn inward through said openings in said rear plate, the air is drawn over and between said cooling fins.

19. The rear housing of claim 18 wherein said rear plate further includes a plurality of rectifying diodes mounted thereon.

20. The rear housing of claim 19 wherein said rectifying diodes are press fit within pockets formed within said rear plate.

21. The rear housing of claim 18 further including a diode plate located axially outward of said cooling fins such that said cooling fins are positioned between said diode plate and said outer surface of said rear plate, said diode plate having a plurality of rectifying diodes mounted thereon.

22. The rear housing of claim 21 wherein said rear housing further includes a plurality of supports extending axially from said outer surface of said rear plate, said diode plate being mounted to said supports.

23. The rear housing of claim 22 wherein said supports extend axially beyond a top surface of said cooling fins such that there is a gap between said diode plate and said top surface of said cooling fins.

24. The rear housing of claim 18 wherein said rear housing further includes an end cap having a rim portion attached to said rear plate, a dome portion including a cylindrical side wall and an end face, said end face including a plurality of vents formed therein to allow ambient air be drawn inward.

25. The rear housing of claim 24 wherein said end cap further includes a plurality of slots formed within said side wall to allow ambient air to be drawn inward.

26. The rear housing of claim 25 wherein said slots within said sidewall of said end cap are radially aligned with said cooling fins such that ambient air drawn inward through said slots passes over and between said cooling fins of said rear housing.

27. The rear housing of claim 24 further including a heat sink mounted onto said rear plate.

28. The rear housing of claim 27 wherein said heat sink includes a plurality of axially extending radially aligned cooling fins, said cooling fins of said hear sink being axially aligned with said vents in said end cap such that ambient air drawn in through said vents passes over and between said cooling fins of said heat sink.
